(19) United States
(12) Patent Application Publication
(10) Pub. No.: US 2005/0218837 A1
(43) Pub. Date: Oct. 6, 2005

(54) Method of triggering at least one illuminating means and triggering circuit for practicing such method

(75) Inventor: Volker Zipf, Plochingen (DE)

Correspondence Address: WARN, HOFFMANN, MILLER & LALONE, .P.C, PO BOX 70098, ROCHESTER HILLS, MI, 48307, US

(73) Assignee: Schefenacker Vision Systems Germany GmbH, Esslingen (DE)

(21) Appl. No.: 11/043,402

(22) Filed: Jan. 26, 2005

(30) Foreign Application Priority Data
Jan. 26, 2004 (DE) 10 2004 003 844.9

(51) Int. Cl. G09G 3/10

(52) U.S. Cl. 315/291

(57) ABSTRACT

Method of triggering at least one illuminating means, and triggering circuit for carrying out such method. On motor vehicles, the illuminating means are increasingly being formed by LEDs. Owing to the great possible operating voltages of the on-board network, such illuminants cause great power losses at high voltages. Besides, the networks aboard motor vehicles are often unstable. So that reliable operation will be possible with simple design layout, the illuminating means is operated in pulse mode when a certain current/voltage level is exceeded. The triggering circuit has a microcontroller, which is supplied with a part of the current/voltage signal supplied to the illuminating means. The microcontroller has an output to which the illuminating means is connected with interposition of a switch. In pulse mode, the ascent of the power loss is substantially reduced. Brightness fluctuations are regulated out. The triggering and the triggering circuit are advantageously employed for motor vehicle lamps.

### CROSS-REFERENCE TO RELATED APPLICATION

This application claims priority to German Patent Application No. 10 2004 003 844.9 filed on Jan. 26, 2004.

### FIELD OF THE INVENTION

The present invention relates to a method of triggering at least one illuminating means, and to a triggering circuit for practicing such method.

### BACKGROUND OF THE INVENTION

On motor vehicles, the illuminating means increasingly takes the form of LEDs. With these lamps, there is the problem that owing to the possible high operating voltages of the network aboard, which usually lie between 9 and 16 volts, the lamps generate great power losses at high voltages. If the lamps are designed for full brightness at the typical rated operating voltage of 13.5 V, distinctly higher power outputs result when such lamps are employed in a 16 V on-board network, since the bias resistance design boosts the current more than proportionally. The components present in the lamp, such as LEDs, resistors, elements of synthetic material and the like, thus reach their load limits, since the temperature in the lamp and on the conductor plates increases sharply owing to the more than proportional current increase. At today's packing densities of the LEDs in the lamps, safeties must be built into the lamp design for this reason. This leads to a high technical outlay. To keep it reasonably low, the brightness of the lamps is not fully utilized at rated voltage on this account. Also, cooling devices are provided, but this again leads to an additional design outlay.

Another problem consists in that present-day motor vehicle on-board networks always become unstable. This is attributable to the increasing number of auxiliary electrical systems with great current demand in the motor vehicle. Examples of such auxiliary electrical systems are electric steering, window raisers, accessory heating and the like. These systems are liable to frequent voltage breakdowns, especially in the case of fast-responding LED lamps specifically. These voltage breakdowns manifest themselves in clearly visible brightness fluctuations.

### SUMMARY OF THE INVENTION

It is an object of the invention to configure the method and the triggering circuit that, with a simple design layout, dependable operation is assured.

By the method according to the invention, the illuminating means, preferably an LED, is operated in pulse mode when the preassigned current/voltage value is exceeded. If the initial voltage lies above this preassigned value, the said rise of initial voltage is compensated by the pulsed operation. This considerably reduces the power loss rise. Owing to the pulsed operation, brightness fluctuations of the illuminating means can be regulated out very well. If the supply voltage of the illuminating means remains below the current/voltage values, operation takes place with no pulses, so that no brightness is lost. Only at voltages above the preassigned current/voltage value will operation be switched to pulse mode with the triggering circuit according to the invention.

For triggering various illuminating means, the microcontroller advantageously comprises corresponding inputs and outputs. A plurality of illuminating means may be combined into one illuminating field. In a single lamp, several illuminating fields may be present. Thus such illuminating fields may, for example in the tail lamp of a motor vehicle, be the brake light, the tail light or the blinker. It is also possible to provide one lamp for one illuminating field in each instance. The distribution of the illuminating means over a single one or among a plurality of lamps may be determined arbitrarily. For these different configurations, a single microcontroller suffices, by which the various illuminating means may be switched to pulsed operation in the manner described.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 shows a schematic diagram of a triggering circuit according to the invention;

FIG. 2 shows an embodiment of the triggering circuit according to the invention by way of example.

### DETAILED DESCRIPTION OF THE PREFERRED EMBODIMENTS

The following description of the preferred embodiment(s) is merely exemplary in nature and is in no way intended to limit the invention, its application, or uses.

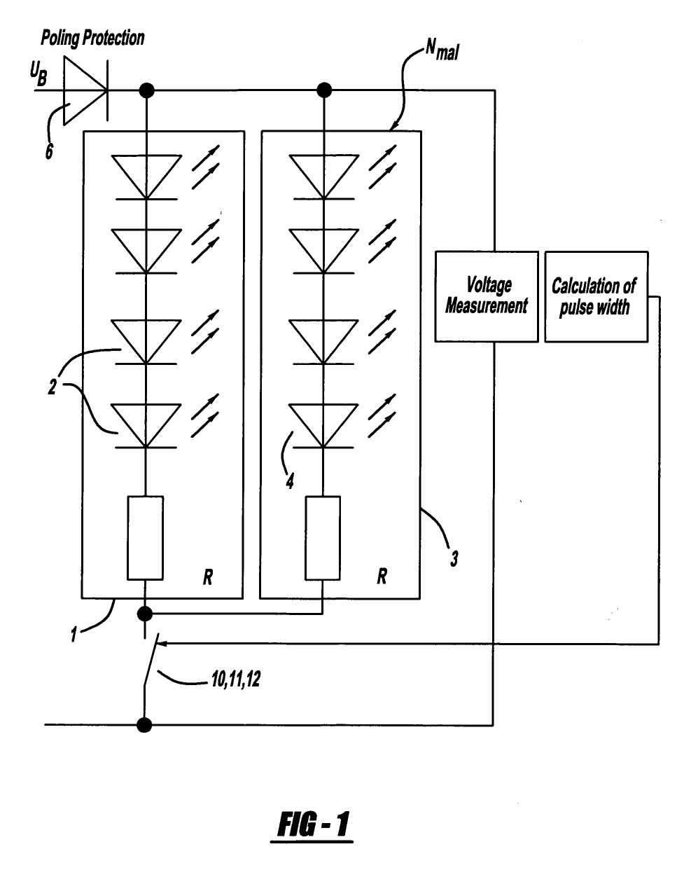

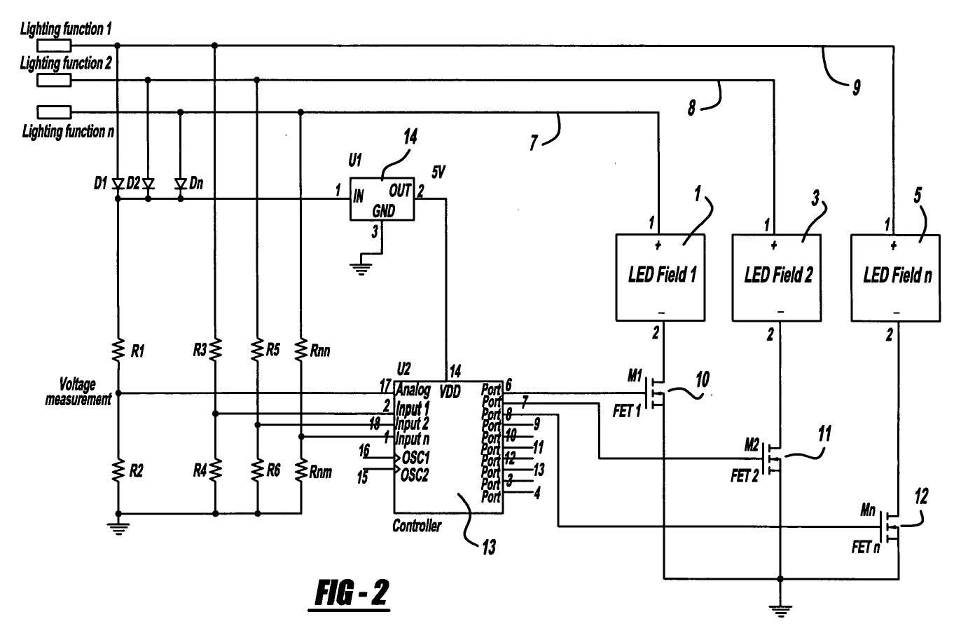

The triggering serves to trigger illuminating means. In the embodiment shown by way of example, an illuminating field 1 comprises a plurality of illuminating means 2, preferably LEDs, connected in series. The illuminating field 1, for example, is provided with four illuminating means 2 connected in series. In FIG. 1, for example, an additional illuminating field 3 is represented, likewise comprising a plurality of illuminating means 4, preferably LEDs, connected in series one behind another. In this way, additional illuminating fields may be provided, circuited parallel to each other in each instance. In FIG. 2, for example, an additional third illuminating field 5 is represented, likewise comprising illuminating means in the form of LEDs. The LEDs form LED fields 1, 3, 5, each performing a lighting function.

The illuminating fields 1, 3, 5 are supplied with the on-board voltage of the motor vehicle. The on-board voltage is usually between 9 and 16 volts. The illuminating fields 1, 3, 5 are preceded by pole protection 6 (FIG. 1) in the form of a barrier diode. The illuminating fields represented by way of example may be the brake light, the stop light, the blinker, or the short-circuit lamp of the motor vehicle. Each illuminating field receives a voltage signal 7 to 9. Each illuminating field 1, 3, 5 is connected by way of a switch 10 to 12 to a microcontroller 13. The switches 10 to 12 are advantageously Mosfets, employed in a manner yet to be described for timing and/or pulsed operation of the illuminating means 2, 4 of the illuminating fields 1, 3, 5.

The voltage signals 7 to 9 are each supplied to a voltage component 14, connected to the VDD input of the microcontroller 13, by way of a diode D1, D2, Dn. By way of the diodes D1, D2, Dn, a part of the voltage is coupled out to the voltage supply of the microprocessor 13. The illumination desired for the particular illuminating field 1, 3, 5 is communicated to the inputs Input 1, Input 2, Input n as input signal. Each input Input 1, Input 2, Input n is preceded by a resistor R3, R5, Rnn.

By way of the input signals present at the inputs Input 1, Input 2, Input n, the desired light requirements for the particular illuminating field 1, 3, 5 are communicated to the microcontroller 13.

At the analog input 17 of the microcontroller 13, a fixedly adjusted portion of the input voltage U_{B} for a measurement is available. With the resistors R1 and R2, the portion of the input voltage can be fixed. On the basis of the voltage signal present at the analog input 17, the brightness in the particular illuminating field can be compensated in each instance.

On the basis of the input signals present to the microcontroller 13 at the inputs Input 1, Input 2, Input n, the microcontroller generates voltage signals at the outputs port 6, port 7, port 8 with which the illuminating fields 1, 3, 5 are activated in the desired manner.

The voltage present at the particular illuminating field 1, 3, 5 is measured by means of the microcontroller 13. As soon as the voltage measured by the microcontroller 13 lies above the rated value, the microcontroller 13 triggers the corresponding switch 10, 11, 12. The rated value advantageously lies somewhat below the on-board network voltage U_{B}, so that in event of load collapse, sufficient regulating reserves will be available. As soon as the voltage lies above the rated value, the triggering circuit switches to pulse mode. The microcontroller 13 computes the pulse width on the basis of the input voltages present at Input 1, Input 2, Input n and, by way of the outputs port 6 to port 8, delivers corresponding signals to the switches 10 to 12. The pulse width is adjusted variably according to the input voltage. The switches 10 to 12 switch at very high frequencies, advantageously above 100 Hz. As a result, no stroboscopic effects occur, so that the LEDs 2, 4 do not flicker, so that no brightness fluctuations are apparent despite pulse mode. In this way, the loss increase is reduced.

In FIG. 1, the operation of the triggering circuit as described is represented schematically. As long as it is determined upon voltage measurements that the supply voltage of the illuminating fields lies below the rated value, the switches 10 to 12 remain closed. The LEDs 2, 4 are therefore not operated in pulse mode, so that the LEDs give off their light at optimum brightness. It is only at voltages lying above the rated value that there is a switch to pulse mode by way of the microcontroller 13, the switches 10 to 12 being actuated. The higher the supply voltage of the illuminating fields 1, 3, 5, the shorter the pulses.

The components of the triggering circuit are advantageously seated in the lamp. The voltage measurement might alternatively take place externally, outside of the lamp. The corresponding voltage values can then be supplied to the microcontroller 13 by way of a bus.

With the triggering circuit described, the rise of the power loss can be considerably reduced at the upper voltage limits, without need for any great outlay.

If for example the illuminating field 1 is dimensioned to a rated voltage of 13.5 volts, this will result in power loss of:
Pₜₒₜ=U_{bat, nom}·I_{LED, Target}
The bias resistance R (FIG. 1) figures out to:

$${R}_{nom} = \frac{( {U}_{bat , nom} - {U}_{F , Dioden} )}{{I}_{LED , Target}}$$

If the rated voltage is specified as 13.5 volts and the voltage of the diodes at 2.5 volts each, then for four diodes the voltage U_{p,diodes} of 10 volts results. Further, it is assumed that the amperage I_{LED,Target} is 60 mA.

From the above relationships, a bias resistance of 58 ohms and a power loss Pₜₒₜ of 0.81 watts results.

Now if the lamp is operated unpulsed at 16 volts, the resulting power loss is:
Pₜₒₜ=U_{bat}·I_{LED,actual}
Here the actual amperage can be calculated as follows:

$${I}_{LED , actual} = \frac{( {U}_{bat} - {U}_{FDioden} )}{{R}_{nom}}$$

If the rated battery voltage U_{bat,nom} is assumed to be 16 volts, the diode voltage 2.5 volts and the bias resistance 58 ohms, then we have the actual amperage _{LED,actual} 103 mA and the power loss Pₜₒₜ 1.65 watts.

This shows that the power loss at the upper voltage limits, in this example at 16 volts, has risen to more than double, compared to a rated voltage of 13.5 volts.

But if the lamp is operated at 16 volts with the triggering circuit described, then the power loss Pₜₒₜ is substantially less. In the example, it is assumed that the ratio of LED and is proportional to the brightness, for example in that the double amperage corresponds to a double brightness. The key ratio turns out to be:

$$D = \frac{{U}_{bat , nom} - {U}_{F , Dioden}}{{U}_{bat , actual} - {U}_{F , Dioden}}$$

So the pulsing begins at voltages lying above rated. The power loss calculates to:
Pₜₒₜ=U_{bat}·I_{LED,actual}·D

Here the actual amperage of the LEDs figures out to:

$${I}_{LED , actual} = \frac{( {U}_{bat} - {U}_{F , Dioden} )}{{R}_{nom}}$$

For the rated battery voltage U_{bat,nom}, 16 volts is assumed; for the diode voltage U_{f,diodes}, 2.5 volts, and for the bias resistance R, 59 ohms. At an assumed key ratio of D=0.58, on the basis of the above relationship we get a power loss Pₜₒₜ of only 0.955 watts. Therefore the reduction of the power loss by the pulsed operation is 0.955 watts/1.65 watts=42%.

With the use of the triggering circuit, the effective current is kept about constant in pulse mode, so that the particular illuminating field in pulse mode seems always about equally bright.

The illuminating fields 1, 3, 5 are operated independently of each other. Depending on the input signal, the microcontroller 13 generates the corresponding pulse width for pulsed operation for each illuminating field. The illuminating fields 1, 3, 5 can be provided in a single lamp. Such a lamp may for example be the tail lamp of a motor vehicle. Then the illuminating fields are for example the brake light, the reverse light or the blinker. Alternatively, however, a lamp may be provided for one illuminating field at a time. The distribution of the illuminating means 2, 4 on a single or over several lamps may be determined arbitrarily. Thus each of the illuminating fields 1, 3, 5 may comprise more or fewer than the four illuminating means 2, 4 represented by way of example.

The description of the invention is merely exemplary in nature and, thus, variations that do not depart from the gist of the invention are intended to be within the scope of the invention. Such variations are not to be regarded as a departure from the spirit and scope of the invention.

1. Method of triggering at least one illuminating means, of at least one lamp, the illuminating means being supplied with current/voltage, wherein the illuminating means is operated in pulse mode when a certain current/voltage value is exceeded.

2. Method according to claim 1, wherein the illuminating means is operated with variable pulse width.

3. Method according to claim 2, wherein the pulse width is adjusted as a function of the current/voltage signals supplied to the illuminating means.

4. Method according to claim 1, wherein said certain current/voltage value is not reached, a change is made to normal operation without timing.

5. Method according to claim 1, wherein said certain current/voltage value lies below the operating voltage.

6. Method according to claim 1, having a pulse frequency above about 100 Hz.

7. A triggering circuit for triggering at least one illuminating means comprising at least one lamp operated in a pulse mode, said triggering circuit comprising at least one microcontroller to which part of a current/voltage signal supplied to the illuminating means is supplied and which comprises at least one output to which the illuminating means is connected with interposition of a switch.

8. The triggering circuit according to claim 7, wherein part of the operating voltage is present at one input of the microcontroller.

9. The triggering circuit according to claim 7, wherein the inputs of the microcontroller are preceded by at least one resistor.

10. The triggering circuit according to claim 7, wherein the supply voltage of the microcontroller is supplied by way of at least one diode.

11. The triggering circuit according to claim 7, wherein the switch is a Mosfet.

12. The triggering circuit according to claim 7, wherein a plurality of illuminating means are combined to make an illuminating field.

13. The triggering circuit according to claim 12, wherein the illuminating means are in series in the illuminating field.

14. The triggering circuit according to claim 12, wherein a plurality of illuminating fields are connected to the microcontroller.

15. The triggering circuit according to claim 14, wherein a plurality of illuminating fields are provided in a lamp.

16. The triggering circuit according to claim 14, wherein one lamp is provided per illuminating field.

17. A method of triggering at least one source of illumination comprising the steps of;
a) providing at least one lamp in said source of illumination;
b) supplying a current voltage to said at least one lamp;
c) operating said lamp in a pulse mode when a certain current/voltage value is exceeded.

18. The method according to claim 17, wherein the lamp is operated with a variable pulse width.

19. The method according to claim 18, wherein the pulse width is adjusted as a function of the current/voltage signals supplied to the lamp.

20. The method according to claim 17, wherein said certain current/voltage value is not reached, a change is made to normal operation without timing.

21. The method according to claim 17, wherein said certain current/voltage value reached lies below the operating voltage.

22. The method according to claim 1, further comprising a pulse frequency above about 100 Hz.
